(19) United States
(12) Patent Application Publication
(10) Pub. No.: US 2014/0287318 A1
(43) Pub. Date: Sep. 25, 2014

(54) ELECTRODE AND METHOD FOR MANUFACTURING AN ELECTRODE

(71) Applicants: Silvan HIPPCHEN, Sersheim (DE); Andreas NETZ, Ludwigsburg (DE)

(72) Inventors: Silvan HIPPCHEN, Sersheim (DE); Andreas NETZ, Ludwigsburg (DE)

(73) Assignee: Robert Bosch GmbH, Stuttgart (DE)

(21) Appl. No.: 14/218,556

(22) Filed: Mar. 18, 2014

(30) Foreign Application Priority Data
Mar. 20, 2013 (DE) 10 2013 204 852.1

(51) Int. Cl. H01M 4/04; H01M 4/139; H01M 4/13

(52) U.S. Cl. CPC H01M 4/0404; H01M 4/13; H01M 4/139
USPC 429/233; 427/58

(57) ABSTRACT

A method for manufacturing an electrode, including the following method steps: providing an active material mixture containing solvent; providing a preformed current collector; applying the solvent-containing, active material mixture to at least a partial region of the current collector to form an active material layer; and drying the active material layer. Such a method provides a particularly cost-effective manner of being able to manufacture an electrode without waste. Also described is an electrode.

### FIELD OF THE INVENTION

The present invention relates to an electrode. The present invention further relates to a method for manufacturing an electrode.

### BACKGROUND INFORMATION

In the manufacturing of electrodes, such as foil-type electrodes for, for instance, lithium ion cells, the battery material is often applied to a current collector in the form of a slurry, the current collector being able to be a current collector foil. In this case, the current collector foil is mostly a metallic foil, the metal being selected as a function of the electrode to be manufactured. In this context, the current collector foil may be unrolled from a roll prior to the coating and rolled up again after the coating. In addition, the coated current collector foil is dried, for instance, using convection drying or IR-drying, in which the solvent of the slurry may be expelled. In most cases, calendering is subsequently carried out, in order to adjust the porosity formed, for instance, during drying.

A method for manufacturing a battery electrode is known, for example, from the documents German Published Patent Appln. No. 10 2010 062 140 and German Published Patent Appln. No. 10 2010 063 143. In such a method, a collector substrate is initially coated substantially completely with an active material, and this coated product is subsequently calendered. In addition, such a method includes removal of material for forming a drain region, and forming the electrode from the collector substrate by cutting out or punching out the electrode.

### SUMMARY

The subject matter of the present invention includes a method for manufacturing an electrode, having the following method steps:
a) providing an active material mixture containing solvent;
b) providing a preformed current collector;
c) applying the solvent-containing, active material mixture to at least a partial region of the current collector to form an active material layer; and
d) drying the active material layer.

A method described above allows an electrode to be manufactured; the advantages of methods known from the related art being able to be substantially retained, but in the process, disadvantages of methods known from the related art being able to be reliably avoided in an inexpensive manner of implementing the method.

To this end, the method for manufacturing an electrode includes, according to method step a), providing an active material mixture containing solvent. In this context, the active material mixture may be designed for a corresponding energy store in a manner known per se. For the exemplary and non-limiting case of manufacturing an electrode for a lithium ion battery, the active material for an anode may include, for example, graphite in a concentration of, preferably, greater than or equal to 94% by weight, whereas the active material for a cathode may include, for example, a lithium salt, such as lithium-nickel-cobalt-manganese-oxide (NCM) or lithium-manganese-oxide (LMO), preferably, in a concentration of greater than or equal to 93% by weight. Therefore, the active material is, in particular, a material or a substance or a mixture of substances, which may participate in the active charging operations or discharging operations of an energy store. In this context, the active material mixture may further include a binder, such as polyvinylidene fluoride (PVDF), preferably, in a concentration of less than or equal to 4%-5% by weight, in which the above-described material is distributed. In addition, a conductive additive, such as conductive carbon compounds, for instance, carbon black, may be added in a concentration of, preferably, less than or equal to 2% by weight.

Furthermore, the active material mixture of method step a) contains solvent. This means that the active material is prepared together with the further components, in particular, as described above, together with a solvent. In this context, solids that are present may be suspended, for instance, in the solvent, which means that the active material mixture may form a slurry, for instance. In this context, the type of solvent may be a function of, in particular, the type of materials used. In general, and in a non-limiting manner, suitable solvents may include water or N-methylpyrrolidone (NMP) or methyl ethyl ketone (MEK).

Furthermore, according to method step b), a preformed current collector is provided. Such a current collector may be made of a material known per se. For example, for the case in which a cathode is produced, the current collector may be made of aluminum, whereas for the case in which an anode is produced, the current collector may be made of copper, for example.

In addition, the current collector according to method step b) is already preformed. In the spirit of the present invention, a preformed current collector may mean, in particular, that at this time, thus, essentially prior to being provided with an electrode material and/or with the active material mixture, the current collector may already have its desired, in particular, final, shape. Thus, the need for subsequent cutting-out, punching-out or the like is eliminated.

In a further method step c), the solvent-containing, active material mixture, as is described above with reference to method step a), is applied to at least a partial region of the current collector to form an active material layer. Consequently, in this method step, the active material mixture is applied to the preformed current collector. In principle, this application may be carried out in any manner known per se for electrode manufacturing.

Finally, according to method step d), the active material layer, which was produced in the above-described method step c), is dried. Drying may be accomplished, for example, under the influence of increased temperature and, for instance, under reduced pressure, and is used, in particular, for the purpose of driving out or removing the solvent, in order to obtain, in this manner, a dry active material layer.

Consequently, the above-described method is based, in particular, on using a current collector already brought into shape, and consequently, developed, in particular, into its final shape or into its final geometry, and on providing it with the active material to form an active material layer or electrode material layer. This may prevent a current collector already coated with the active material from still being shaped, for example, by cutting-out or punching.

In this context, the above-described method may have, in particular, the advantages, that the disadvantages or the risks, which are involved when shaping, e.g., cutting, the coated current collector for later operation, may be reduced or completely eliminated.

Specifically, the above-described method may prevent burrs from cutting or stamping being formed, which could have a negative influence on the later operation or the possible performance of the electrode. In addition, particles, which may separate from the active material layer during shaping, may be prevented from causing a short circuit in the cell at an unwanted location during later operation, and from damaging or destroying it in this manner. On the contrary, the present invention may allow particularly long-lasting and reliable operation of an electrode.

Furthermore, after coating the current collector, a sturdy electrode may be obtained, in which the active material layer or regions of it do not flake off as a result of mechanical loading from stamping; or, for instance, in the case of laser cutting, deformation does not occur at the edge region of the electrode or the material, or the electrode composition does not change due to a high energy yield caused by the laser. Since such effects, as described above, are unwanted in electrodes, cutting waste of the coated material of the related art is often produced. However, such cutting waste may be prevented by the present invention, which may reduce the process costs due to, in particular, the high material costs within the value-added chain of the battery costs, and in this manner, may allow particularly cost-effective manufacturing.

In addition, a particularly defined embodiment may be produced without negative influences that reduce performance, which means that the performance data may be developed to be particularly high and defined.

In summary, it consequently allows the above-described method to produce electrodes particularly cost-effectively, precisely, and with a high performance grade of the electrodes to be operated later.

Within the scope of one embodiment, a current collector foil may be used as a current collector. In this context, a current collector foil may have, in particular, a low thickness with respect to the length and width, and in the process, it may be designed to be approximately foil-like, and thus, particularly flexible. The above-described method may be especially suitable for, in particular, foil-type current collectors or for current collector foils, since in the case of foil-type current collectors, in particular, a negative effect on the electrode structure may not always be able to be completely prevented during shaping. Therefore, current collector foils, in particular, require an especially gentle manufacturing method, in order to be able to produce a waste-free, defined structure. Non-limiting thicknesses of current collector foils, which may be formed from aluminum in the case of a cathode, and from copper in the case of an anode, lie, for example and in a non-limiting manner, in a range of greater than or equal to 5 μm and/or less than or equal to 50 μm. In this context, the thickness of the current collector foils may be selected, in particular, as a function of the desired rigidity of the electrode and/or the rigidity of the active material layer, as such. If, for example, the active material layer has a sufficient rigidity, the thickness of the current collector foils may be selected to be correspondingly low. If, however, the active material or the active material layer does not have sufficient rigidity in itself, a greater thickness of the current collector may be advantageous.

In the scope of a further embodiment, method step c) may be carried out using a mask. In particular, using a mask, precisely defined patterns of the active material layer may be applied to the current collector by masking or covering regions of the current collector not to be coated. Consequently, wanted and precisely defined regions, which, for example, are not intended to be provided with an active material, may be spared a coating. For example, current pick-ups or other contact areas, or regions which are supposed to be provided with further components, may not be provided with active material. Consequently, in this embodiment, a particularly freely selectable electrode structure may also be produced in the case of the above-described method, which may increase the scope of application of the method even further. For example, masks, which are made of solvent-resistant materials, e.g., in the form of bands or foils (tapes), may be used as masks. Suitable solvent-resistant materials include, for instance, polypropylene (PP) and/or polyethylene (PE) or also polyethylene terephthalate (Mylar foil).

In the scope of a further embodiment, a current pick-up may be positioned on the current collector prior to method step c). Thus, in this embodiment, particularly sturdy attachment of the current pick-up, which may be made of the same material as the current collector, is feasible. For in regard to the attachment, no consideration has to be given to active material that is present, and the current pick-up may already be developed during the shaping of the current collector. In this context, when the active material is applied, a current pick-up may be protected from being provided with active material, by taking suitable measures. For example, as described above in one embodiment, in particular, when a current pick-up is present, it may be covered with a mask, so that coating of the current pick-up with an active material may be ruled out. In this context, a current pick-up may be, in particular, a component, which is attached to the current collector that brings together the current flow of the electrodes, and electrically connects, in particular, the electrodes, i.e., the current collector to an outer contact. In addition, the current collector may be formed in one piece with the current pick-up. For example, the current pick-up may be formed as a current pick-up flag.

In the scope of a further embodiment, method step c) may be carried out, using screen printing, printing, spraying, or using slit dies. Such methods are particularly well-suited for applying the solvent-containing, active material or the solvent-containing, active material mixture to a current collector in a wet-chemical manner. In addition, the above-mentioned methods are fully developed technically and are therefore applicable in a cost-effective manner. Furthermore, in particular, the above-mentioned methods may be used in an advantageous manner to apply, for instance, in combination with a mask, a precisely defined pattern of the active material mixture to the current collector, which means that in this specific embodiment, highly defined products electrodes may be produced.

In the scope of a further embodiment, the edge regions of the current collector may be provided peripherally with an active material layer. In this embodiment, a particularly high performance is possible through especially effective utilization of the surface area of the current collector. In this embodiment, as well, it is, in this context, particularly advantageous that the current collector is shaped prior to coating it with the active material mixture, since a consequence of this is a considerable simplification of the method. Therefore, especially in this embodiment, electrodes, whose edge regions are provided particularly thickly with the active material mixture, may be produced. In this context, peripheral provision with active material may mean, in particular, that the lateral regions are provided essentially completely with active material.

In the scope of a further embodiment, the current collector may be preformed by cutting or stamping. In this embodiment, particularly highly exact electrode structures may be produced in this context, the electrode structures having an especially defined geometry. In addition, the above-mentioned methods are essentially fully developed technically and are also easily applicable in methods for manufacturing electrodes. Consequently, the advantages of these shaping methods may also be retained in the above-described methods, but without their disadvantages occurring during forming of a current collector coated with active material.

Regarding further advantages and features, reference is explicitly made here to the explanations, in connection with the electrode of the present invention and the figure. In addition, features and advantages of the method of the present invention shall also be considered to be applicable to, and revealed with respect to, the electrode of the present invention, and vice versa.

An electrode, which is manufactured as described above, is also subject matter of the present invention. In particular, such electrodes may be able to be produced particularly inexpensively and may have, in this context, an especially defined structure. In addition, such electrodes may be tailored particularly easily, which means that they have a particularly broad field of application.

Regarding further advantages and features, reference is explicitly made here to the explanations, in connection with the method of the present invention and the figure. In addition, features and advantages of the electrode of the present invention shall also be considered to be applicable to, and revealed with respect to, the method of the present invention, and vice versa.

### BRIEF DESCRIPTION OF THE DRAWING

FIG. 1 shows a schematic representation of a method step of a method according to the present invention.

### DETAILED DESCRIPTION

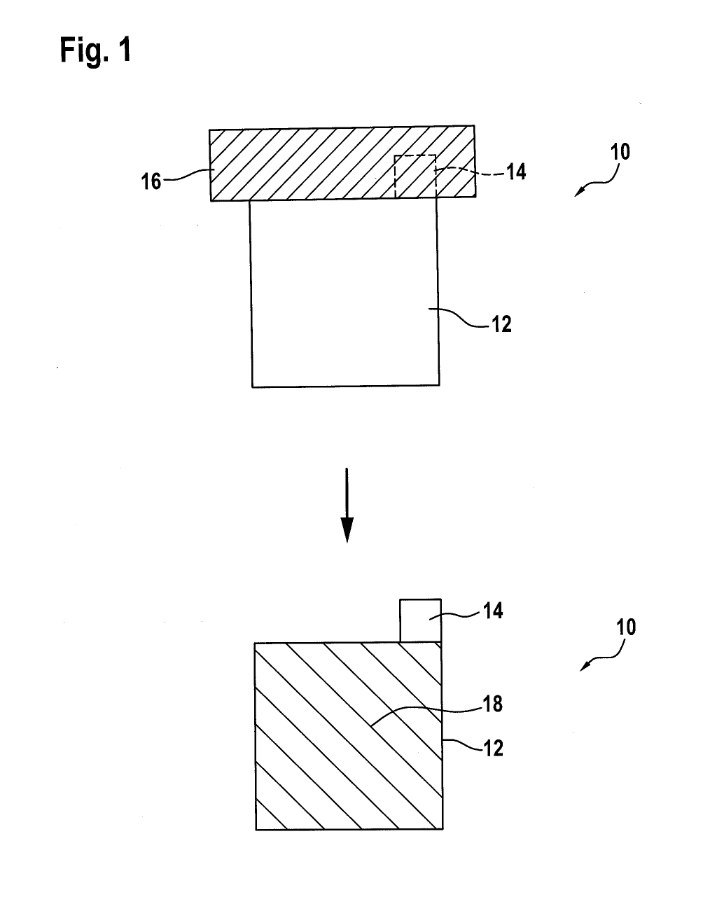

A method step for manufacturing an electrode 10 is shown in FIG. 1. In particular, the step of coating current collector 12 with an active material mixture is shown in FIG. 1. Such an electrode 10 may be part of a lithium ion battery, for example, and may be used, as such, in both consumer electronics and electrically powered vehicles.

In this context, it is apparent from FIG. 1 that current collector 12, which may be, for instance, a current collector foil, may be preformed, in particular, prior to applying the active material mixture, by cutting or stamping, for instance. Furthermore, a current pick-up 14, such as a current pick-up flag, may be positioned on current collector 12.

In this context, shown in FIG. 1 is the application of the, in particular, solvent-containing, active material mixture to at least a partial region of current collector 12, to form an active material layer 18. This may be carried out, using screen printing, printing, spraying, or using a slit die method. In this context, in order to protect, e.g., current pick-up 14 from being coated, a mask 16 is used, which covers current pick-up 14. Subsequently, applied active material layer 18 is dried.

What is claimed is:

1. A method for manufacturing an electrode, comprising:
providing an active material mixture containing a solvent;
providing a preformed current collector;
applying the solvent-containing, active material mixture to at least a partial region of the current collector to form an active material layer; and
drying the active material layer.

2. The method as recited in claim 1, wherein a current collector foil is used as the current collector.

3. The method as recited in claim 1, wherein the applying is carried out using a mask.

4. The method as recited in claim 1, wherein prior to the applying a current pick-up is positioned at the current collector.

5. The method as recited in claim 1, wherein the applying is carried out using one of screen printing, printing, spraying, and with the aid of slit dies.

6. The method as recited in claim 1, wherein edge regions of the current collector are provided peripherally with the active material layer.

7. The method as recited in claim 1, wherein the current collector is preshaped by one of cutting and stamping.

8. An electrode, manufactured according to a method for manufacturing the electrode, comprising:
providing an active material mixture containing a solvent;
providing a preformed current collector;
applying the solvent-containing, active material mixture to at least a partial region of the current collector to form an active material layer; and
drying the active material layer.
